(19) United States
(12) Patent Application Publication
(10) Pub. No.: US 2023/0077397 A1
(43) Pub. Date: Mar. 16, 2023

(54) POLYIMIDE PRECURSOR SOLUTION, POROUS POLYIMIDE MEMBRANE, AND INSULATED ELECTRIC WIRE

(71) Applicant: FUJIFILM Business Innovation Corp., Tokyo (JP)

(72) Inventors: Takeshi IWANAGA, Kanagawa (JP); Shigeru SEITOKU, Kanagawa (JP); Kosuke NAKADA, Kanagawa (JP); Hidekazu HIROSE, Kanagawa (JP)

(73) Assignee: FUJIFILM Business Innovation Corp., Tokyo (JP)

(21) Appl. No.: 17/702,776

(22) Filed: Mar. 23, 2022

(30) Foreign Application Priority Data
Sep. 1, 2021 (JP) 2021-142715

(51) Int. Cl. C08G 73/12; C08G 73/10

(52) U.S. Cl. CPC C08G 73/126; C08G 73/1067; C08G 73/1007

(57) ABSTRACT

A polyimide precursor solution includes an aqueous solvent including water, a polyimide precursor, resin particles, and an ionization agent X having a boiling point of 100° C. or more and 130° C. or less and an ionization agent Y having a boiling point of 250° C. or more and 300° C. or less.

### CROSS-REFERENCE TO RELATED APPLICATIONS

This application is based on and claims priority under 35 USC 119 from Japanese Patent Application No. 2021-142715 filed Sep. 1, 2021.

### BACKGROUND

### (i) Technical Field

The present disclosure relates to a polyimide precursor solution, a porous polyimide membrane, and an insulated electric wire.

### (ii) Related Art

Japanese Unexamined Patent Application Publication No. 2019-011383 discloses “a polyimide precursor solution including an aqueous solvent, resin particles providing a particle size distribution curve having at least two maximums that are Maximum [PL] on the smaller size side and Maximum [PH] on the larger size side, and a polyimide precursor”.

Japanese Unexamined Patent Application Publication No. 2017-091627 discloses “an insulated electric wire including a linear conductor and an insulating layer disposed on the outer circumference side of the conductor, wherein the insulating layer includes a matrix including a synthetic resin as a main component, plural fillers and plural pores dispersed in the matrix, and the insulating layer has a storage modulus of 3.0 GPa or more”.

### SUMMARY

In the related art, porous polyimide membranes formed so as to have increased porosity to have an improved insulating property tend to have lowered membrane flexural strength. Aspects of non-limiting embodiments of the present disclosure relate to providing, as a polyimide precursor solution including an aqueous solvent including water, a polyimide precursor, resin particles, and two or more ionization agents, compared with “a case where the ionization agents include an ionization agent having a boiling point of less than 100° C. or more than 130° C. and an ionization agent having a boiling point of less than 250° C. or more than 300° C.” or “a case where an ionization agent having the highest boiling point and an ionization agent having the lowest boiling point have a boiling point difference of less than 100° C. or more than 200° C.”, a polyimide precursor solution that provides a porous polyimide membrane that is good in terms of both of the insulating property and the membrane flexural strength.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided a polyimide precursor solution including an aqueous solvent including water, a polyimide precursor, resin particles, and an ionization agent X having a boiling point of 100° C. or more and 130° C. or less and an ionization agent Y having a boiling point of 250° C. or more and 300° C. or less.

### BRIEF DESCRIPTION OF THE DRAWINGS

Exemplary embodiments of the present disclosure will be described in detail based on the following figures, wherein:

FIG. 1A is a schematic view illustrating an example of the porous structure in a porous polyimide membrane formed from a polyimide precursor solution in the related art;

FIG. 1B is a schematic view illustrating an example of the porous structure in a porous polyimide membrane formed from a polyimide precursor solution in the related art in which the content of resin particles is increased;

FIG. 1C is a schematic view illustrating an example of the porous structure in a porous polyimide membrane formed from a polyimide precursor solution according to an exemplary embodiment; and

FIG. 2 is a schematic view illustrating an example of the form of a porous polyimide membrane formed from a polyimide precursor solution according to an exemplary embodiment.

### DETAILED DESCRIPTION

Hereinafter, exemplary embodiments of the present disclosure will be described. Such descriptions and Examples are mere examples of exemplary embodiments and do not limit the scope of the exemplary embodiments.

In this Specification, among numerical ranges described in series, the upper limit value or the lower limit value of a numerical range may be replaced by the upper limit value or the lower limit value of one of other numerical ranges described in series. For numerical ranges described in the present disclosure, the upper limit value or the lower limit value of such a numerical range may be replaced by a value described in Examples.

In this Specification, components may each include plural corresponding substances.

In this Specification, in the case of referring to the amount of each of components in a composition, the amount means, when the composition contains plural substances belonging to such a component, the total amount of the plural substances in the composition unless otherwise specified.

In the present exemplary embodiment, “membrane” is a concept encompassing not only articles ordinarily referred to as “membranes”, but also articles ordinarily referred to as “films” and “sheets”.

### Polyimide Precursor Solution

A polyimide precursor solution according to a first exemplary embodiment includes an aqueous solvent including water, a polyimide precursor, resin particles, an ionization agent X having a boiling point of 100° C. or more and 130° C. or less, and an ionization agent Y having a boiling point of 250° C. or more and 300° C. or less.

A polyimide precursor solution according to a second exemplary embodiment includes an aqueous solvent including water, a polyimide precursor, resin particles, an ionization agent X having a boiling point of 80° C. or more, and an ionization agent Y having a higher boiling point than the ionization agent X, wherein the ionization agent X and the ionization agent Y have a boiling point difference (Y−X) of 100° C. or more and 200° C. or less.

In this Specification, features shared by the first exemplary embodiment and the second exemplary embodiment will be collectively described as features according to “the present exemplary embodiment”.

Hereinafter, for porous polyimide membranes formed from polyimide precursor solutions in the related art and a porous polyimide membrane formed from a polyimide precursor solution according to the present exemplary embodiment, examples of porous structures in the membranes will be described with reference to drawings.

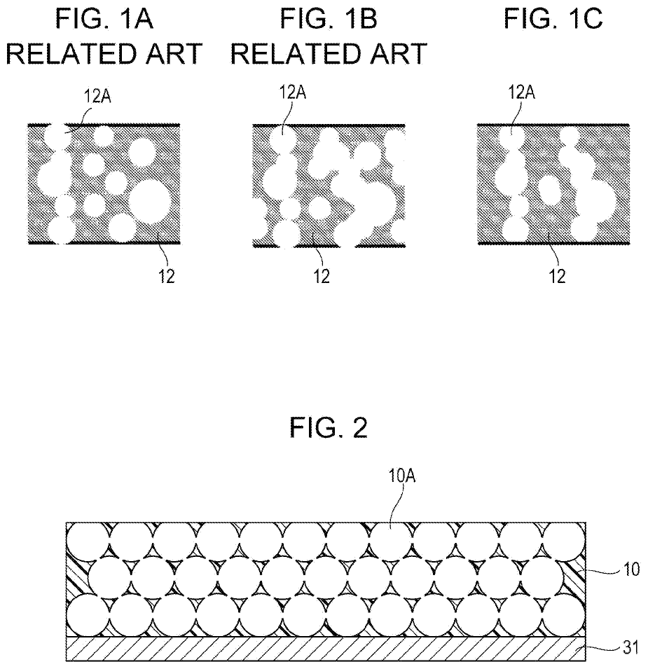

FIG. 1A is a schematic view illustrating an example of the porous structure in a porous polyimide membrane formed from a polyimide precursor solution in the related art.

FIG. 1B is a schematic view illustrating an example of the porous structure in a porous polyimide membrane formed from a polyimide precursor solution in the related art in which the content of resin particles is increased.

FIG. 1C is a schematic view illustrating an example of the porous structure in a porous polyimide membrane formed from a polyimide precursor solution according to the present exemplary embodiment.

FIGS. 1A to 1C illustrate pores 12A and porous polyimide membranes 12.

The porous polyimide membranes have been attracting attention as materials for covering electric wires, for example. Such a porous polyimide membrane can be formed by steps of, for example, applying a polyimide precursor solution onto a base, for example, and subsequently heat-drying the applied solution such that regions of resin particles are partially turned into pores due to thermal decomposition of resin particles, to thereby provide a porous structure.

Porous polyimide membranes in the related art tend to have an insufficient insulating property. This is inferentially because, for example, as illustrated in FIG. 1A, the membranes have low porosity or, even when pores are appropriately present, the pores are distributed randomly with low irregularity.

In the related art, as a technique of improving the insulating property of porous polyimide membranes, there is a known technique of increasing the ratio of resin particles in the polyimide precursor solution. However, when the ratio of resin particles is excessively increased in the solution, in the step of providing a porous structure, resin particles densely present in the coated membrane are turned into pores, so that, as illustrated in FIG. 1B, pores tend to be formed in a wide region of the membrane. As a result, the membrane may have an improved insulating property, but tends to undergo a decrease in the membrane flexural strength.

By contrast, the polyimide precursor solution according to the present exemplary embodiment has the above-described features, so that a porous polyimide membrane that is good in terms of both of the insulating property and the membrane flexural strength may be provided. The reasons for this are not necessarily clear, but are inferred as follows.

The polyimide precursor solution according to the first exemplary embodiment contains, in the solution, an ionization agent X having a boiling point of 100° C. or more and 130° C. or less and an ionization agent Y having a boiling point of 250° C. or more and 300° C. or less. When the solution contains the ionization agent X having an appropriately low boiling point and the ionization agent Y having an appropriately high boiling point, the solution may tend to keep an appropriate viscosity during formation of a membrane, and the resin particles and the polyimide precursor may tend to be compatible with each other. Thus, for example, as illustrated in FIG. 1C, a membrane having an appropriate porosity and a pore size distribution having two or more peaks may tend to be formed. This may inferentially result in a porous polyimide membrane that is good in terms of both of the insulating property and membrane flexural strength.

On the other hand, the polyimide precursor solution according to the second exemplary embodiment contains, in the solution, an ionization agent X having a boiling point of 80° C. or more and an ionization agent Y having a higher boiling point than the ionization agent X, wherein the ionization agent X and the ionization agent Y have a boiling point difference (Y−X) of 100° C. or more and 200° C. or less.

When the solution contains the ionization agent X having a boiling point of 80° C. or more and the ionization agent Y having a boiling point difference (Y−X) from the ionization agent X in an appropriate range, the solution may tend to keep an appropriate viscosity during formation of a membrane, and the resin particles and the polyimide precursor may tend to be compatible with each other. Thus, for example, as illustrated in FIG. 1C, a membrane having an appropriate porosity and a pore size distribution having two or more peaks may tend to be formed. This may inferentially result in a porous polyimide membrane that is good in terms of both of the insulating property and membrane flexural strength.

Hereinafter, the polyimide precursor solution and the porous polyimide membrane according to the present exemplary embodiment will be described in detail with reference to drawings. Note that, in the drawings, the same or corresponding elements are denoted by like reference signs, and descriptions will not be repeated.

### Aqueous Solvent

The aqueous solvent is an aqueous solvent including water.

Examples of the water include distilled water, ion-exchanged water, ultrafiltered water, and pure water.

The water content relative to the whole aqueous solvent is preferably 50 mass % or more. When the water content is adjusted so as to satisfy this numerical range, the aqueous solvent may have a lower boiling point. This may further facilitate, in the gaps between the polyimide precursor molecules, boiling of the aqueous solvent. This may cause formation of a larger number of pores due to evaporation of the aqueous solvent, to facilitate formation of a structure in which the pores are connected together.

The water content relative to the whole aqueous solvent is more preferably 70 mass % or more and 100 mass % or less, still more preferably 80 mass % or more and 100 mass % or less.

The aqueous solvent may include a solvent other than water.

The solvent other than water is preferably water-soluble. The term “water-soluble” means that 1 mass % or more of the substance dissolves in water at 25° C.

Examples of the solvent other than water include water-soluble organic solvents and aprotic polar solvents. The solvent other than water is preferably aprotic polar solvents.

Examples of the water-soluble organic solvents include water-soluble ether-based solvents, water-soluble ketone-based solvents, and water-soluble alcohol-based solvents.

Such a water-soluble ether-based solvent is a water-soluble solvent having an ether bond in a single molecule. Examples of the water-soluble ether-based solvent include tetrahydrofuran (THF), dioxane, trioxane, 1,2-dimethoxyethane, diethylene glycol dimethyl ether, and diethylene glycol diethyl ether. Of these, preferred examples of the water-soluble ether-based solvent include tetrahydrofuran and dioxane.

Such a water-soluble ketone-based solvent is a water-soluble solvent having a ketone group in a single molecule. Examples of the water-soluble ketone-based solvent include acetone, methyl ethyl ketone, and cyclohexanone. Of these, the water-soluble ketone-based solvent is preferably acetone.

Such a water-soluble alcohol-based solvent is a water-soluble solvent having an alcoholic hydroxy group in a single molecule. Examples of the water-soluble alcohol-based solvent include methanol, ethanol, 1-propanol, 2-propanol, tert-butylalcohol, ethylene glycol, monoalkyl ethers of ethylene glycol, propylene glycol, monoalkyl ethers of propylene glycol, diethylene glycol, monoalkyl ethers of diethylene glycol, 1,2-propanediol, 1,3-propanediol, 1,3-butanediol, 1,4-butanediol, 2,3-butanediol, 1,5-pentanediol, 2-butene-1,4-diol, 2-methyl-2,4-pentanediol, glycerol, 2-ethyl-2-hydroxymethyl-1,3-propanediol, and 1,2,6-hexanetriol. Of these, preferred examples of the water-soluble alcohol-based solvent include methanol, ethanol, 2-propanol, ethylene glycol, monoalkyl ethers of ethylene glycol, propylene glycol, monoalkyl ethers of propylene glycol, diethylene glycol, and monoalkyl ethers of diethylene glycol.

Such an aprotic polar solvent may be a solvent having a boiling point of 150° C. or more and 300° C. or less and a dipole moment of 3.0 D or more and 5.0 D or less. Specific examples of the aprotic polar solvent include N-methyl-2-pyrrolidone (NMP), N,N-dimethylformamide (DMF), N,N-dimethylacetamide (DMAc), dimethyl sulfoxide (DMSO), hexamethylenephosphoramide (HMPA), N-methylcaprolactam, N-acetyl-2-pyrrolidone, 1,3-dimethyl-2-imidazolidinone (DMI), N,N′-dimethylpropylene urea, tetramethyl urea, trimethyl phosphate, and triethyl phosphate.

The aqueous solvent may include, as the solvent other than water, an aprotic polar solvent. In the aqueous solvent, the content of the aprotic polar solvent relative to 100 parts by mass of the total mass of particles insoluble in the polyimide precursor solution (resin particles and optionally included inorganic particles) is preferably 1 part by mass or more and 50 parts by mass or less.

When the aqueous solvent includes, as the solvent other than water, an aprotic polar solvent, the content of the aprotic polar solvent relative to 100 parts by mass of the particles is more preferably 3 parts by mass or more and 45 parts by mass or less, still more preferably 5 parts by mass or more and 45 parts by mass or less.

As the aqueous solvent, for example, in the resin particle dispersion liquid prepared in the step of producing the polyimide precursor solution, the aqueous solvent having been used during polymerization of a tetracarboxylic acid dianhydride and a diamine compound in the resin particle dispersion liquid may be directly used.

As the aqueous solvent, for example, in a case where the polyimide precursor solution further includes, as other particles, inorganic particles, the aqueous solvent in the inorganic particle dispersion liquid prepared in the production step may be directly used.

The ionization agent X and the ionization agent Y according to the present exemplary embodiment may ionize the polyimide precursor to provide the effect of increasing the solubility of the polyimide precursor in the aqueous solvent and the effect of accelerating imidization; these effects may tend to become stronger when the water content of the aqueous solvent relative to the whole aqueous solvent is 50 mass % or more. Thus, in the polyimide precursor solution, the water content relative to the whole aqueous solvent may be 50 mass % or more.

### Resin Particles

The resin particles, which are not particularly limited, are resin particles formed of a resin other than polyimide. Examples include resin particles formed of a resin obtained by polycondensation of polymerizable monomers, such as a polyester resin or a urethane resin, and resin particles formed of a resin obtained by radical polymerization of a polymerizable monomer, such as a vinyl resin, an olefin resin, or a fluororesin. Examples of the resin particles obtained by radical polymerization include resin particles of a (meth)acrylic resin, a (meth)acrylic acid ester resin, a styrene-(meth)acrylic resin, a polystyrene resin, or a polyethylene resin.

Of these, the resin particles are preferably formed of at least one selected from the group consisting of a (meth)acrylic resin, a (meth)acrylic acid ester resin, a styrene-(meth)acrylic resin, and a polystyrene resin.

Note that, in the present exemplary embodiment, “(meth)acrylic” means that it encompasses “acrylic” and “methacrylic”.

The resin particles may be crosslinked or not crosslinked. From the viewpoint of, in the step of imidizing the polyimide precursor, effective contribution to relaxation of the residual stress, resin particles not crosslinked are preferred. Furthermore, the polyimide precursor solution, from the viewpoint of simplifying the step of producing the polyimide precursor solution, more preferably contains, as the resin particles, vinyl resin particles obtained by emulsion polymerization.

When the resin particles are vinyl resin particles, they are obtained by polymerizing a monomer. Examples of the monomer for the vinyl resin include the following monomers: styrenes having a styrene skeleton such as styrene, alkyl-substituted styrenes (for example, α-methylstyrene, 2-methylstyrene, 3-methylstyrene, 4-methylstyrene, 2-ethylstyrene, 3-ethylstyrene, and 4-ethylstyrene), halogen-substituted styrenes (for example, 2-chlorostyrene, 3-chlorostyrene, and 4-chlorostyrene), and vinylnaphthalene; esters having a vinyl group such as methyl (meth)acrylate, ethyl (meth)acrylate, n-propyl (meth)acrylate, n-butyl (meth)acrylate, lauryl (meth)acrylate, 2-ethylhexyl (meth)acrylate, and trimethylolpropane trimethacrylate (TMPTMA); vinylnitriles such as acrylonitrile and methacrylonitrile; vinyl ethers such as vinyl methyl ether and vinyl isobutyl ether; vinyl ketones such as vinyl methyl ketone, vinyl ethyl ketone, and vinyl isopropenyl ketone; acids such as (meth)acrylic acid, maleic acid, cinnamic acid, fumaric acid, and vinylsulfonic acid; and bases such as ethyleneimine, vinylpyridine, and vinylamine. These example monomers are polymerized to provide vinyl resin units.

Another monomer may be additionally used: for example, a monofunctional monomer such as vinyl acetate, a bifunctional monomer such as ethylene glycol dimethacrylate, nonane diacrylate, or decanediol diacrylate, or a polyfunctional monomer such as trimethylolpropane triacrylate or trimethylolpropane trimethacrylate.

The vinyl resin may be a resin formed from a single species of such a monomer alone, or a resin that is a copolymer of two or more species of such monomers.

The resin particles, from the viewpoint of having improved dispersibility and suppressing occurrence of pinholes, may have an acidic group in the surfaces. The acidic group present in the surfaces of the resin particles may inferentially form a salt with a base (such as an organic amine compound) used for dissolving the polyimide precursor in the aqueous solvent, to function as a dispersing agent for the resin particles. This may inferentially result in the improved dispersibility of the resin particles in the polyimide precursor solution.

The acidic group in the surfaces of the resin particles is not particularly limited, and may be at least one selected from the group consisting of a carboxy group, a sulfonic group, and a phenolic hydroxy group. Of these, a carboxy group is preferred.

A monomer for forming resin particles having an acidic group in the surfaces is not particularly limited as long as it is a monomer having an acidic group. Examples include a monomer having a carboxy group, a monomer having a sulfonic group, a monomer having a phenolic hydroxy group, and salts of the foregoing.

Specific examples include monomers having a sulfonic group such as p-styrenesulfonic acid and 4-vinylbenzenesulfonic acid; monomers having a phenolic hydroxy group such as 4-vinyldihydrocinnamic acid, 4-vinylphenol, and 4-hydroxy-3-methoxy-1-propenylbenzene; monomers having a carboxy group such as acrylic acid, crotonic acid, methacrylic acid, 3-methylcrotonic acid, fumaric acid, maleic acid, 2-methylisocrotonic acid, 2,4-hexadienedioic acid, 2-pentenoic acid, sorbic acid, citraconic acid, 2-hexenoic acid, and monoethyl fumarate; and salts of the foregoing. Such a monomer having an acidic group may be mixed with a monomer not having an acidic group and polymerized; alternatively, a monomer not having an acidic group may be polymerized to form particles and subsequently, on the surfaces, the monomer having an acidic group may be polymerized. Such monomer species may be used alone or in combination of two or more thereof.

Of these, preferred are monomers having a carboxy group such as acrylic acid, crotonic acid, methacrylic acid, 3-methylcrotonic acid, fumaric acid, maleic acid, 2-methylisocrotonic acid, 2,4-hexadienedioic acid, 2-pentenoic acid, sorbic acid, citraconic acid, 2-hexenoic acid, monoethyl fumarate, and salts of the foregoing. Such monomer species having a carboxy group may be used alone or in combination of two or more thereof.

In other words, the resin particles having an acidic group in the surfaces preferably have a skeleton derived from at least one monomer having a carboxy group selected from the group consisting of acrylic acid, crotonic acid, methacrylic acid, 3-methylcrotonic acid, fumaric acid, maleic acid, 2-methylisocrotonic acid, 2,4-hexadienedioic acid, 2-pentenoic acid, sorbic acid, citraconic acid, 2-hexenoic acid, monoethyl fumarate, and salts of the foregoing.

When the monomer having an acidic group and the monomer not having an acidic group are mixed together and polymerized, the amount of the monomer having an acidic group is not particularly limited; however, when the amount of the monomer having an acidic group is excessively small, the resin particles may have lowered dispersibility in the polyimide precursor solution; when the amount of the monomer having an acidic group is excessively large, polymer aggregates may be generated during emulsion polymerization. For this reason, the amount of the monomer having an acidic group relative to all monomers is preferably 0.3 mass % or more and 20 mass % or less, more preferably 0.5 mass % or more and 15 mass % or less, particularly preferably 0.7 mass % or more and 10 mass % or less.

On the other hand, when the monomer not having an acidic group is subjected to emulsion polymerization and subsequently the monomer having an acidic group is further added and polymerized, similarly from the above-described viewpoint, the amount of the monomer having an acidic group relative to all monomers is preferably 0.01 mass % or more and 10 mass % or less, more preferably 0.05 mass % or more and 7 mass % or less, particularly preferably 0.07 mass % or more and 5 mass % or less.

As described above, the resin particles are preferably not crosslinked; however, in the case of crosslinking the resin particles and using, as at least a part of monomer components, a crosslinking agent, the ratio of the crosslinking agent to all the monomer components is preferably 0 mass % or more and 20 mass % or less, more preferably 0 mass % or more and 5 mass % or less, particularly preferably 0 mass %.

When the monomer used for a resin forming vinyl resin particles contains styrene, the ratio of styrene to all the monomer components is preferably 20 mass % or more and 100 mass % or less, more preferably 40 mass % or more and 100 mass % or less.

Note that the resin particles may be provided by, on the surfaces of a commercially available product, further polymerizing the monomer having an acidic group. Specific examples of the crosslinked resin particles include crosslinked polymethyl methacrylate (MBX series, manufactured by SEKISUI PLASTICS CO., Ltd.), crosslinked polystyrene (SBX series, manufactured by SEKISUI PLASTICS CO., Ltd.), and methyl methacrylate-styrene copolymer crosslinked resin particles (MSX series, manufactured by SEKISUI PLASTICS CO., Ltd.).

Examples of the resin particles not crosslinked include polymethyl methacrylate (MB series, manufactured by SEKISUI PLASTICS CO., Ltd.) and (meth)acrylic acid ester-styrene copolymers (FS series, manufactured by Nippon Paint Co., Ltd.).

The resin particles preferably have a volume-average particle size of 0.1 μm or more and 1 μm or less, more preferably 0.25 μm or more and 0.98 μm or less, still more preferably 0.25 μm or more and 0.95 μm or less.

The resin particles preferably have a volume-based particle size distribution index (GSDv) of 1.30 or less, more preferably 1.25 or less, still more preferably 1.20 or less.

The resin particles, from the viewpoint of providing a porous polyimide membrane that is better in terms of both of the insulating property and membrane flexural strength, may provide a particle size distribution curve having a single maximum alone.

The volume-average particle size and volume-based particle size distribution of the resin particles are determined in the following manner. A laser-diffraction particle size distribution analyzer (for example, COULTER COUNTER LS13, manufactured by Beckman Coulter, Inc.) is used to perform measurement to obtain a volume-based particle size distribution. The obtained particle size distribution is divided into particle size ranges (channels). Over these channels, a volume-based cumulative distribution curve is drawn from smaller particle sizes to larger particle sizes, to provide a particle size distribution curve. Note that the particle size distribution curve is drawn on the basis of the number of particles counted in 50 nm increments. A particle size corresponding to a cumulative value of 50% relative to all the particles is measured as volume-average particle size D50v.

The volume-based particle size distribution index of the resin particles is calculated, from the particle size distribution of the particles in the polyimide precursor solution, as (D84v/D16v)^{1/2}. In the particle-volume-based cumulative distribution curve drawn from smaller particle sizes to larger particle sizes, a particle size corresponding to a cumulative value of 16% is defined as volume-based particle size D16v, and a particle size corresponding to a cumulative value of 50% is defined as volume-average particle size D50v.

The volume content ratio of the resin particles to the polyimide precursor (particles/polyimide precursor) is preferably 40/60 or more and 80/20 or less, more preferably 45/55 or more and 78/22 or less, still more preferably 50/50 or more and 74/26 or less.

The content of the resin particles relative to the total mass of the polyimide precursor and the particles is preferably 30 mass % or more and 85 mass % or less, and the content relative to the total mass of the polyimide precursor and the particles is more preferably 35 mass % or more and 80 mass % or less, still more preferably 40 mass % or more and 80 mass % or less.

In the related art, in the case of forming a porous polyimide membrane from a polyimide precursor solution not including the ionization agent X or the ionization agent Y according to the present exemplary embodiment, in order to form a membrane that is good in terms of the insulating property, the ratio of the resin particles tends to be increased: for example, the volume content ratio of the resin particles to the polyimide precursor is adjusted to be excessively high for the resin particles (for example, more than 80/20), or the content of the resin particles is increased (for example, more than 85 mass %). In the polyimide precursor solution according to the present exemplary embodiment, even when the resin particles satisfy such a range, the solution, which includes the ionization agent X and the ionization agent Y according to the present exemplary embodiment, may provide a porous polyimide membrane that is good in terms of the insulating property inferentially.

When the polyimide precursor solution contains resin particles so as to satisfy such a range, during production of a porous polyimide membrane by applying the polyimide precursor solution to form a coating membrane, the resin particles may tend to be present throughout the coating membrane. Thus, pores formed by removing the resin particles may tend to be present throughout the film, to facilitate formation of a structure in which pores are connected together. Even when the polyimide precursor solution contains the particles so as to satisfy such a range, the dispersibility of the particles may be ensured, a high coatability may be provided, and a dry film having high strength may be formed.

### Ionization Agent

The ionization agent according to the first exemplary embodiment contains the ionization agent X having a boiling point of 100° C. or more and 130° C. or less and the ionization agent Y having a boiling point of 250° C. or more and 300° C. or less.

The ionization agent according to the second exemplary embodiment contains the ionization agent X having a boiling point of 80° C. or more and the ionization agent Y having a higher boiling point than the ionization agent X, wherein the ionization agent X and the ionization agent Y have a boiling point difference (Y−X) of 100° C. or more and 200° C. or less.

Note that the boiling point means a boiling point at the atmospheric pressure.

### Ionization Agent X and Ionization Agent Y

The ionization agent X according to the first exemplary embodiment has a boiling point of 100° C. or more and 130° C. or less, from the viewpoint of providing a porous polyimide membrane that is better in terms of both of the insulating property and membrane flexural strength, preferably 105° C. or more and 125° C. or less, more preferably 110° C. or more and 120° C. or less.

The ionization agent X according to the second exemplary embodiment has a boiling point of 80° C. or more, from the viewpoint of providing a porous polyimide membrane that is better in terms of both of the insulating property and membrane flexural strength, preferably has a boiling point of 100° C. or more and 130° C. or less, more preferably 105° C. or more and 125° C. or less, still more preferably 110° C. or more and 120° C. or less.

The ionization agent Y according to the first exemplary embodiment has a boiling point of 250° C. or more and 300° C. or less, from the viewpoint of providing a porous polyimide membrane that is better in terms of both of the insulating property and membrane flexural strength, preferably has a boiling point of 255° C. or more and 290° C. or less, more preferably a boiling point of 260° C. or more and 280° C. or less.

The ionization agent Y according to the second exemplary embodiment, from the viewpoint of providing a porous polyimide membrane that is better in terms of both of the insulating property and membrane flexural strength, preferably has a boiling point of 250° C. or more and 300° C. or less, preferably a boiling point of 255° C. or more and 290° C. or less, more preferably a boiling point of 260° C. or more and 280° C. or less.

In the first exemplary embodiment, from the viewpoint of providing a porous polyimide membrane that is better in terms of both of the insulating property and membrane flexural strength, the ionization agent X and the ionization agent Y preferably have a boiling point difference (Y−X) of 100° C. or more and 200° C. or less, more preferably 120° C. or more and 200° C. or less, still more preferably 130° C. or more and 180° C. or less, particularly preferably 140° C. or more and 160° C. or less.

In the second exemplary embodiment, the ionization agent X and the ionization agent Y have a boiling point difference (Y−X) of 100° C. or more and 200° C. or less, from the viewpoint of providing a porous polyimide membrane that is better in terms of both of the insulating property and membrane flexural strength, preferably 120° C. or more and 200° C. or less, more preferably 130° C. or more and 180° C. or less, still more preferably 140° C. or more and 160° C. or less.

Hereinafter, the ionization agent including both of the ionization agent X and the ionization agent Y will be simply referred to as “ionization agent according to the present exemplary embodiment”. The ionization agent according to the present exemplary embodiment may include an ionization agent other than the ionization agent X and the ionization agent Y (hereafter, also referred to as “other ionization agent”).

The ionization agent X according to the present exemplary embodiment is not particularly limited as long as it has a boiling point in the above-described range; the ionization agent X, for example, from the viewpoint of providing a porous polyimide membrane that is better in terms of both of the insulating property and membrane flexural strength, preferably includes an organic amine compound. Such ionization agents X according to the present exemplary embodiment may be used alone or in combination of two or more thereof.

The ionization agent Y according to the present exemplary embodiment is not particularly limited as long as it has a boiling point in the above-described range or the ionization agent X and the ionization agent Y have a boiling point difference (Y−X) in the above-described range. Examples of the ionization agent Y according to the present exemplary embodiment include propylene carbonate and organic amine compounds. Of these, the ionization agent Y, from the viewpoint of providing a porous polyimide membrane that is better in terms of both of the insulating property and membrane flexural strength, preferably includes an organic amine compound. Such ionization agents Y according to the present exemplary embodiment may be used alone or in combination of two or more thereof.

### Organic Amine Compound

The organic amine compound may be a primary amine compound, a secondary amine compound, or a tertiary amine compound. Such organic amine compounds may be used alone or in combination of two or more thereof.

Examples of the primary amine compound include methylamine, ethylamine, n-propylamine, isopropylamine, 2-ethanolamine, and 2-amino-2-methyl-1-propanol (also simply referred to as “aminomethylpropanol”).

Examples of the secondary amine compound include dimethylamine, 2-(methylamino)ethanol, 2-(ethylamino)ethanol, 4-methylimidazole, 2-methylmorpholine, and morpholine.

Examples of the tertiary amine compound include 2-dimethylaminoethanol, 2-diethylaminoethanol, 2-dimethylaminopropanol, pyridine, 2-methylpyridine, triethylamine, picoline, N-methylmorpholine (4-methylmorpholine), N-ethylmorpholine, 1,2-dimethylimidazole, and 2-ethyl-4-methylimidazole.

Of these, the organic amine compound, from the viewpoint of providing a porous polyimide membrane that is better in terms of both of the insulating property and membrane flexural strength, preferably includes at least one selected from secondary amine compounds and tertiary amine compounds.

The organic amine compound may be an amine compound having a nitrogen-containing heterocyclic structure (in particular, a tertiary amine compound having a nitrogen-containing heterocyclic structure). Examples of the amine compound having a nitrogen-containing heterocyclic structure (hereafter, referred to as “nitrogen-containing heterocyclic amine compound”) include isoquinolines (amine compounds having an isoquinoline skeleton), pyridines (amine compounds having a pyridine skeleton), pyrimidines (amine compounds having a pyrimidine skeleton), pyrazines (amine compounds having a pyrazine skeleton), piperazines (amine compounds having a piperazine skeleton), triazines (amine compounds having a triazine skeleton), imidazoles (amine compounds having an imidazole skeleton), morpholines (amine compounds having a morpholine skeleton), polyaniline, polypyridine, and polyamine.

The organic amine compound, from the viewpoint of providing a porous polyimide membrane that is better in terms of both of the insulating property and membrane flexural strength, preferably includes at least one selected from the group consisting of morpholines, pyridines, piperidines, and imidazoles, more preferably includes at least one selected from the group consisting of morpholines and imidazoles, still more preferably includes at least one selected from the group consisting of imidazoles represented by the following General formula (IM) and morpholines represented by the following General formula (MO).

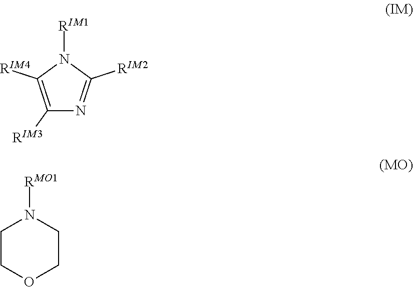

In General formula (IM), R^{IM1}, R^{IM2}, R^{IM3}, and R^{IM4} each independently represent a hydrogen atom or an alkyl group having 1 or more and 8 or less carbon atoms.

In General formula (MO), R^{MO1} represents a hydrogen atom or an alkyl group having 1 or more and 8 or less carbon atoms.

In General formula (IM) and General formula (MO), the alkyl groups represented by R^{IM1} to R^{IM4} and R^{MO1} may be linear or branched.

The alkyl groups represented by R^{IM1} to R^{IM4} and R^{MO1} are preferably an alkyl group having 1 or more and 6 or less carbon atoms, more preferably an alkyl group having 1 or more and 4 or less carbon atoms.

The ionization agent X and the ionization agent Y according to the present exemplary embodiment may each include an organic amine compound. When the ionization agent X and the ionization agent Y each include an organic amine compound, these agents may have improved affinity for each other, turn the polyimide precursor into an amine salt to increase its solubility in the aqueous solvent, and also function as an imidization accelerator. This may tend to result in formation of a porous polyimide membrane that is better in terms of both of the insulating property and membrane flexural strength.

In the present exemplary embodiment, from the viewpoint of providing a porous polyimide membrane that is better in terms of both of the insulating property and membrane flexural strength, preferably, the ionization agent X is selected, as an organic amine compound, from the morpholines represented by General formula (MO) above, and the ionization agent Y is selected, as an organic amine compound, from the imidazoles represented by General formula (IM) above.

The organic amine compound may be a compound except for the diamine serving as a raw material of the polyimide precursor. The organic amine compound may be a monovalent amine compound or a di- or higher polyvalent amine compound. Use of a di- or higher polyvalent amine compound may facilitate formation of pseudo-crosslinked structures between the molecules of the polyimide precursor, and may facilitate improvement in the storage stability of the polyimide precursor solution.

### Content

The total amount of the ionization agent according to the present exemplary embodiment (specifically, the amount of both of the ionization agent X and the ionization agent Y according to the present exemplary embodiment) is, from the viewpoint of providing a porous polyimide membrane that is better in terms of both of the insulating property and membrane flexural strength, relative to the carboxy group (—COOH) of the polyimide precursor in the polyimide precursor solution, preferably 50 mol % or more and 500 mol % or less, more preferably 80 mol % or more and 250 mol % or less, still more preferably 90 mol % or more and 200 mol % or less.

The content of the ionization agent X according to the present exemplary embodiment is, from the viewpoint of providing a porous polyimide membrane that is better in terms of both of the insulating property and membrane flexural strength, relative to the polyimide precursor, preferably 1 equivalent or more and 20 equivalents or less, more preferably 2 equivalents or more and 15 equivalents or less, still more preferably 3 equivalents or more and 10 equivalents or less.

The ionization agent X and the ionization agent Y according to the present exemplary embodiment have an equivalent ratio (X/Y) of, from the viewpoint of providing a porous polyimide membrane that is better in terms of both of the insulating property and membrane flexural strength, preferably 1 or more and 30 or less, more preferably 2 or more and 20 or less, still more preferably 3 or more and 15 or less.

### Polyimide Precursor

The polyimide precursor is obtained by polymerizing a tetracarboxylic dianhydride and a diamine compound. Specifically, the polyimide precursor is a resin having a repeating unit represented by General formula (I) (polyamic acid).

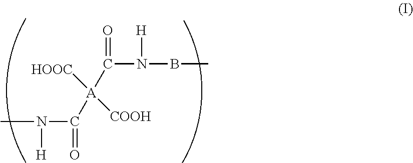

In General formula (I), A represents a tetravalent organic group and B represents a divalent organic group.

In General formula (I), the tetravalent organic group represented by A is a residue in which, from the tetracarboxylic dianhydride serving as a raw material, the four carboxyl groups have been removed.

On the other hand, the divalent organic group represented by B is a residue in which, from the diamine compound serving as a raw material, the two amino groups have been removed.

Thus, the polyimide precursor having the repeating unit represented by General formula (I) is a polymer formed from the tetracarboxylic dianhydride and the diamine compound.

The tetracarboxylic dianhydride may be an aromatic or aliphatic compound, but is preferably an aromatic compound. Thus, in General formula (I), the tetravalent organic group represented by A is preferably an aromatic organic group.

Examples include pyromellitic anhydride, 3,3′,4,4′-benzophenonetetracarboxylic dianhydride, 3,3′,4,4′-diphenylsulfonetetracarboxylic dianhydride, 4,4′-oxydiphthalic anhydride, 3,4′-oxydiphthalic anhydride, 3,3′,4,4′-biphenyltetracarboxylic dianhydride, 2,3,3′,4′-biphenyltetracarboxylic dianhydride, 4,4′-(hexafluoroisopropylidene)diphthalic anhydride, 2,2-bis(3,4-dicarboxyphenyl)propane dianhydride, bis(3,4-dicarboxyphenyl)methane dianhydride, 1,4-bis(3,4-dicarboxyphenoxy)benzene dianhydride, 1,4-bis(2,3-dicarboxyphenoxy)benzene dianhydride, p-phenylene bis(trimellitate anhydride), m-phenylene bis(trimellitate anhydride), 2,2-bis[4-(3,4-dicarboxyphenoxy)phenyl]propane dianhydride, naphthalene-1,4,5,8-tetracarboxylic dianhydride, naphthalene-2,3,6,7-tetracarboxylic dianhydride, 9,9-bis(3,4-dicarboxyphenyl)fluorene dianhydride, 4,4′-diphenyl ether bis(trimellitate anhydride), 4,4′-diphenylmethane bis(trimellitate anhydride), 4,4′-bis(3,4-dicarboxyphenoxy)diphenylsulfide dianhydride, 4,4′-bis(3,4-dicarboxyphenoxy)diphenylsulfone dianhydride, 4,4′-bis(3,4-dicarboxyphenoxy)diphenyl ether dianhydride, 2,2-bis(4-hydroxyphenyl)propane bis(trimellitate anhydride), p-terphenyltetracarboxylic dianhydride, and m-terphenyltetracarboxylic dianhydride.

Examples of the aliphatic tetracarboxylic dianhydride include aliphatic or alicyclic tetracarboxylic dianhydrides such as butanetetracarboxylic dianhydride, 1,2,3,4-cyclobutanetetracarboxylic dianhydride, 1,3-dimethyl-1,2,3,4-cyclobutanetetracarboxylic dianhydride, 1,2,3,4-cyclopentanetetracarboxylic dianhydride, 2,3,5-tricarboxycyclopentylacetic dianhydride, 3,5,6-tricarboxynorbornane-2-acetic dianhydride, 2,3,4,5-tetrahydrofurantetracarboxylic dianhydride, 5-(2,5-dioxotetrahydrofuryl)-3-methyl-3-cyclohexene-1,2-dicarboxylic dianhydride, and bicyclo[2,2,2]-oct-7-ene-2,3,5,6-tetracarboxylic dianhydride; and aliphatic tetracarboxylic dianhydrides having an aromatic ring such as 1,3,3a,4,5,9b-hexahydro-2,5-dioxo-3-furanyl)-naphtho[1,2-c]furan-1,3-dione, 1,3,3a,4,5,9b-hexahydro-5-methyl-5-(tetrahydro-2,5-dioxo-3-furanyl)-naphtho[1,2-c]furan-1,3-dione, and 1,3,3a,4,5,9b-hexahydro-8-methyl-5-(tetrahydro-2,5-dioxo-3-furanyl)-naphtho[1,2-c]furan-1,3-dione.

Of these, the tetracarboxylic dianhydride is preferably aromatic tetracarboxylic dianhydrides; specifically, preferred are pyromellitic anhydride, 3,3′,4,4′-benzophenonetetracarboxylic dianhydride, 4,4′-oxydiphthalic anhydride, 3,3′,4,4′-biphenyltetracarboxylic dianhydride, and 2,3,3′,4′-biphenyltetracarboxylic dianhydride, more preferred are pyromellitic dianhydride, 3,3′,4,4′-biphenyltetracarboxylic dianhydride, and 3,3′,4,4′-benzophenonetetracarboxylic dianhydride, and particularly preferred is 3,3′,4,4′-biphenyltetracarboxylic dianhydride.

Note that such tetracarboxylic dianhydrides may be used alone or in combination of two or more thereof.

In the case of using two or more tetracarboxylic dianhydrides in combination, aromatic tetracarboxylic dianhydrides or aliphatic tetracarboxylic dianhydrides may be used in combination, or an aromatic tetracarboxylic dianhydride and an aliphatic tetracarboxylic dianhydride may be used in combination.

On the other hand, the diamine compound is a diamine compound having two amino groups in the molecular structure. The diamine compound may be an aromatic or aliphatic compound, but is preferably an aromatic compound. Thus, in General formula (I), the divalent organic group represented by B is preferably an aromatic organic group.

Examples of the diamine compound include aromatic diamines such as p-phenylenediamine, m-phenylenediamine, 4,4′-diaminodiphenylmethane, 4,4′-diaminodiphenylethane, 4,4′-diaminodiphenyl ether, 4,4′-diaminodiphenyl sulfide, 4,4′-diaminodiphenylsulfone, 1,5-diaminonaphthalene, 3,3-dimethyl-4,4′-diaminobiphenyl, 5-amino-1-(4′-aminophenyl)-1,3,3-trimethylindan, 6-amino-1-(4′-aminophenyl)-1,3,3-trimethylindan, 4,4′-diaminobenzanilide, 3,5-diamino-3′-trifluoromethylbenzanilide, 3,5-diamino-4′-trifluoromethylbenzanilide, 3,4′-diaminodiphenyl ether, 2,7-diaminofluorene, 2,2-bis(4-aminophenyl)hexafluoropropane, 4,4′-methylene-bis(2-chloroaniline), 2,2′,5,5′-tetrachloro-4,4′-diaminobiphenyl, 2,2′-dichloro-4,4′-diamino-5,5′-dimethoxybiphenyl, 3,3′-dimethoxy-4,4′-diaminobiphenyl, 4,4′-diamino-2,2′-bis(trifluoromethyl)biphenyl, 2,2-bis[4-(4-aminophenoxy)phenyl]propane, 2,2-bis[4-(4-aminophenoxy)phenyl]hexafluoropropane, 1,4-bis(4-aminophenoxy)benzene, 4,4′-bis(4-aminophenoxy)-biphenyl, 1,3′-bis(4-aminophenoxy)benzene, 9,9-bis(4-aminophenyl)fluorene, 4,4′-(p-phenyleneisopropylidene)bisaniline, 4,4′-(m-phenyleneisopropylidene)bisaniline, 2,2′-bis[4-(4-amino-2-trifluoromethylphenoxy)phenyl]hexafluoropropane, and 4,4′-bis[4-(4-amino-2-trifluoromethyl)phenoxy]-octafluorobiphenyl; aromatic diamines having two amino groups bonded to an aromatic ring and a heteroatom other than the nitrogen atoms of the amino groups, such as diaminotetraphenylthiophene; and aliphatic diamines and alicyclic diamines such as 1,1-meta-xylylenediamine, 1,3-propanediamine, tetramethylenediamine, pentamethylenediamine, octamethylenediamine, nonamethylenediamine, 4,4-diaminoheptamethylenediamine, 1,4-diaminocyclohexane, isophoronediamine, tetrahydrodicyclopentadienylenediamine, hexahydro-4,7-methanoindanylenedimethylenediamine, tricyclo[6,2,1,0^{2.7}]-undecylenedimethyldiamine, and 4,4′-methylenebis(cyclohexylamine).

Of these, the diamine compound is preferably an aromatic diamine compound; specifically, for example, preferred are p-phenylenediamine, m-phenylenediamine, 4,4′-diaminodiphenylmethane, 4,4′-diaminodiphenyl ether, 3,4′-diaminodiphenyl ether, 4,4′-diaminodiphenyl sulfide, and 4,4′-diaminodiphenylsulfone; particularly preferred are 4,4′-diaminodiphenyl ether and p-phenylenediamine.

Note that such diamine compounds may be used alone or in combination of two or more thereof. In the case of using two or more diamine compounds in combination, aromatic diamine compounds or aliphatic diamine compounds may be used in combination, or an aromatic diamine compound and an aliphatic diamine compound may be used in combination.

In order to adjust the handleability or mechanical properties of the resultant polyimide, two or more of tetracarboxylic dianhydrides and/or diamine compounds may be copolymerized.

Examples of the combination of copolymerization include copolymerization between a tetracarboxylic dianhydride and/or diamine compound having a single aromatic ring in the chemical structure and a tetracarboxylic dianhydride and/or diamine compound having two or more aromatic rings in the chemical structure, and copolymerization between an aromatic tetracarboxylic dianhydride and/or diamine compound and a carboxylic dianhydride and/or diamine compound having a flexible linking group such as an alkylene group, an alkyleneoxy group, or a siloxane group.

The polyimide precursor may have a number-average molecular weight of 1000 or more and 150000 or less, more preferably 5000 or more and 130000 or less, still more preferably 10000 or more and 100000 or less.

When the polyimide precursor has a number-average molecular weight in such a range, a decrease in the solubility of the polyimide precursor in the solvent may be suppressed and the membrane formability may tend to be ensured.

The number-average molecular weight of the polyimide precursor is measured by gel permeation chromatography (GPC) under the following measurement conditions.
Column: TSKgel α-M (7.8 mm I.D×30 cm) from Tosoh Corporation
Eluent: DMF (dimethylformamide)/30 mM LiBr/60 mM phosphoric acid
Flow rate: 0.6 mL/min
Injection amount: 60 μL
Detector: RI (refractive index detector)

The content (concentration) of the polyimide precursor relative to the whole polyimide precursor solution may be 0.1 mass % or more and 40 mass % or less, is preferably 0.5 mass % or more and 25 mass % or less, more preferably 1 mass % or more and 20 mass % or less.

Other Particles other than Resin Particles

The polyimide precursor solution according to the present exemplary embodiment may include other particles other than the resin particles (hereafter, also referred to as “other particles”).

As the other particles, particles insoluble in the polyimide precursor solution are used. In the present exemplary embodiment, “insoluble” also encompasses a case where 3 mass % or less of the substance is soluble in the liquid at 25° C. Other particle species may be used alone or in combination of two or more thereof.

The other particles are, for example, inorganic particles.

Specific examples of the inorganic particles include silica particles, titanium oxide particles, and aluminum oxide particles.

The silica particles may be sol-gel silica obtained by sol-gel processing, or fumed silica obtained by a vapor phase process. The silica particles may be synthesized or a commercially available product. The silica particles may be an aqueous solvent dispersion (for example, SNOWTEX (registered trademark) series, manufactured by Nissan Chemical Industries, Ltd.) or a dry powder (for example, AEROSIL series, manufactured by Evonik Industries). From the viewpoint of dispersibility, as the silica particles, an aqueous dispersion liquid may be used.

The inorganic particles may include a particulate material added for improving mechanical strength, such as silica powder, alumina powder, barium sulfate powder, titanium oxide powder, mica, or talc.

For the inorganic particles, preferred ranges and the measurement method of the volume-average particle size and the volume-based particle size distribution index (GSDv) may be the same as the above-described preferred ranges and the measurement method of the resin particles.

### Other Additives

The polyimide precursor solution according to the present exemplary embodiment may include, for example, a catalyst for accelerating the imidization reaction or a leveling material for improving the quality of membrane formation.

Examples of the catalyst for accelerating the imidization reaction include dehydrating agents such as acid anhydrides and acid catalysts such as phenol derivatives, sulfonic acid derivatives, and benzoic acid derivatives.

The polyimide precursor solution may contain, as a material having a volume-average particle size of 0.001 μm or more and 0.2 μm or less other than the inorganic particles, depending on the usage purpose, for example, a conductive material (conductive (for example, having a volume resistivity of less than 10⁷ Ω·cm) or semi-conductive (for example, having a volume resistivity of 10⁷ Ω·cm or more and 10¹³ Ω·cm or less)) added for imparting conductivity.

Examples of the conductive agent include carbon black (for example, an acidic carbon black having a pH of 5.0 or less); metals (for example, aluminum and nickel); metal oxides (for example, yttrium oxide and tin oxide); and ionic conductive substances (for example, potassium titanate and LiCl). These conductive materials may be used alone or in combination of two or more thereof.

### Method for Producing Polyimide Precursor Solution

Examples of the method of preparing the polyimide precursor solution according to the present exemplary embodiment include the following method (i) and method (ii).

(i) method of preparing a solution of a polyimide precursor, and subsequently adding resin particles and an ionization agent, to obtain the polyimide precursor solution

(ii) method of preparing a resin particle dispersion liquid, and, in the resin particle dispersion liquid, synthesizing a polyimide precursor in the presence of an ionization agent, to obtain the polyimide precursor solution

Of these, as the method of preparing the polyimide precursor solution according to the present exemplary embodiment, from the viewpoint of improving the dispersibility of the resin particles, the method (ii) is preferred.

### (i) Method of Preparing Solution of Polyimide Precursor, and Subsequently Adding Resin Particles and Ionization Agent, to Obtain Polyimide Precursor Solution

The solution of the polyimide precursor before addition of resin particles and an ionization agent can be obtained by a publicly known method. Specifically, for example, in an aqueous solvent, a tetracarboxylic dianhydride and a diamine compound are polymerized to generate a polyimide precursor, to obtain the solution of the polyimide precursor.

In an example of the method, in an organic solvent such as an aprotic polar solvent (for example, N-methylpyrrolidone (NMP)), a tetracarboxylic dianhydride and a diamine compound are polymerized to generate a polyimide precursor and this is subsequently added to an aqueous solvent to precipitate the polyimide precursor; subsequently, in the aqueous solvent, the polyimide precursor is dissolved to obtain the solution of the polyimide precursor to which resin particles and an ionization agent are to be added.

The order and manner of adding, to the solution of the polyimide precursor, the resin particles and the ionization agent are not particularly limited. For example, to the solution of the polyimide precursor, addition of the resin particles may be followed by addition of the ionization agent, addition of the ionization agent may be followed by addition of the resin particles, or the resin particles and the ionization agent may be simultaneously added. The resin particles may be added or mixed in the form of a resin particle dispersion liquid. The ionization agent may be added or mixed in the form of a solution including the ionization agent.

For example, when the resin particles are vinyl resin particles, the vinyl resin particles may be prepared in an aqueous solvent by a publicly known polymerization process (a radical polymerization process such as emulsion polymerization, soap-free emulsion polymerization, suspension polymerization, mini-emulsion polymerization, or micro-emulsion polymerization).

For example, in the case of applying, to production of vinyl resin particles, the emulsion polymerization process, into an aqueous solvent in which a water-soluble polymerization initiator such as potassium persulfate or ammonium persulfate is dissolved, a monomer such as a styrene or (meth)acrylic acid is added. Furthermore, as needed, a surfactant such as sodium dodecyl sulfate or a diphenyl oxide disulfonic acid salt is added, and heating is performed under stirring to cause polymerization. In this way, vinyl resin particles may be prepared.

For example, for the aqueous solvent dispersion liquid including the resin particles, the resin particles in the dispersion liquid may be taken out as powder by a publicly known process such as reprecipitation or freeze-drying, and this powder may be mixed with the solution of the polyimide precursor. Alternatively, the powder may be re-dispersed in an organic solvent in which the resin particles are insoluble, mixed with the solution of the polyimide precursor, and stirred. Note that the processes of mixing, stirring, and dispersion are not particularly limited.

### (ii) Method of Preparing Resin Particle Dispersion Liquid and Synthesizing, in the Resin Particle Dispersion Liquid, Polyimide Precursor in the Presence of Ionization Agent, to Obtain Polyimide Precursor Solution

In an example of the method, an aqueous solvent dispersion liquid of the resin particles is prepared; in this dispersion liquid, in the presence of an ionization agent, a tetracarboxylic dianhydride and a diamine compound are polymerized to generate a polyimide precursor to obtain the polyimide precursor solution according to the present exemplary embodiment.

For example, for the resin particles, from the viewpoint of improving dispersibility in the polyimide precursor solution according to the present exemplary embodiment, the surfaces of the resin particles may be covered with a resin having a chemical structure different from that of the original resin. The resin for covering may be changed in accordance with the solvent employed or the chemical structure of the polyimide precursor. The resin for covering may be, for example, a resin having an acidic group or a basic group.

The method of covering the surfaces of the resin particles with a resin having a chemical structure different from that of the original resin is not particularly limited. In an example of the method, for the resin particles, as the original resin particles, vinyl resin particles are prepared by emulsion polymerization; subsequently a small amount of a monomer having an acidic group or a basic group such as methacrylic acid or 2-dimethylaminoethyl methacrylate is added and polymerization is continuously caused, to thereby cover the surfaces of the vinyl resin particles with a resin different from the vinyl resin.

### Porous Polyimide Membrane

The porous polyimide membrane according to the present exemplary embodiment has a common logarithm of volume resistivity of 13 log Ω·cm or more, and a porosity of 50% or more and 70% or less.

The porous polyimide membrane is, in general, a porous baked product formed from a polyimide precursor solution and having pores. The porous polyimide membrane according to the present exemplary embodiment has the above-described features, so that it may be good in terms of both of the insulating property and membrane flexural strength. The reason for this is not necessarily clear, but is inferred as follows.

The porous polyimide membrane has a common logarithm of volume resistivity of 13 log Ω·cm or more, so that it may inferentially have an appropriate insulating property. The porous polyimide membrane has a porosity of 50% or more and 70% or less, so that the membrane may appropriately have pores, which may inferentially result in good membrane flexural strength.

The porous polyimide membrane according to the present exemplary embodiment, as long as it has a volume resistivity and a porosity satisfying the above-described ranges, may be produced using the polyimide precursor solution according to the present exemplary embodiment or may be produced using a commercially available polyimide precursor solution. The porous polyimide membrane according to the present exemplary embodiment, from the viewpoint of being better in terms of both of the insulating property and membrane flexural strength, may be produced using the above-described polyimide precursor solution according to the present exemplary embodiment.

### Properties of Porous Polyimide Membrane

### Volume Resistivity

The porous polyimide membrane according to the present exemplary embodiment has a common logarithm of volume resistivity of 13 log Ω·cm or more, from the viewpoint of being better in terms of both of the insulating property and membrane flexural strength, preferably 13 log Ω·cm or more and 16 log Ω·cm or less, more preferably 13.5 log Ω·cm or more and 15 log Ω·cm or less.

The common logarithm of volume resistivity can be determined in the following manner.

An electrode having a diameter of 50 mm is prepared and 8340A ULTRA HIGH RESISTANCE METER manufactured by ADC CORPORATION is used at a measurement temperature of 25° C. and a measurement voltage of DC 5V to measure the volume resistance value. From the obtained volume resistance value, the following Formula (1) is used to calculate a volume resistivity and the common logarithm of the volume resistivity is determined.

ρv=(πd^{2/4t})×Rv Formula (1):

ρv: volume resistivity [Ω·cm]

t: thickness of sample [cm]

d: diameter of main electrode [cm]

Rv: volume resistance value [Ω]

### Porosity

The porous polyimide membrane according to the present exemplary embodiment has a porosity of 50 vol % or more and 70 vol % or less, from the viewpoint of being better in terms of both of the insulating property and membrane flexural strength, preferably 55 vol % or more and 68 vol % or less, more preferably 60 vol % or more and 65 vol % or less.

The porosity of the porous polyimide membrane is determined from the apparent density and true density of the porous polyimide membrane. The apparent density d is a value provided by dividing the mass of the porous polyimide membrane (g) by the volume (including pores) of the porous polyimide membrane (cm³). Alternatively, the apparent density d may be determined by dividing the mass per unit area of the porous polyimide membrane (g/m²) by the thickness of the porous polyimide membrane (μm). The true density ρ is a value provided by dividing the mass of the porous polyimide membrane (g) by the volume (excluding the pores) of the porous polyimide membrane (specifically the volume of only the skeleton portions formed of resin) (cm³).

The porosity of the porous polyimide membrane is calculated by the following Formula (II).

Porosity (vol %)={1−(d/ρ)}×100=[1−{(w/t)/ρ)}]×100 Formula (II):

d: apparent density of porous polyimide membrane (g/cm³)

ρ: true density of porous polyimide membrane (g/cm³)

w: mass per unit area of porous polyimide membrane (g/m²)

t: thickness of porous polyimide membrane (μm)

The structure of the pores is not particularly limited as long as the porosity is in such a range; from the viewpoint of being better in terms of both of the insulating property and membrane flexural strength, the pores may be connected together to form an open pore structure.

For the porous polyimide membrane, from the viewpoint of being better in terms of both of the insulating property and membrane flexural strength, the pore distribution curve obtained by mercury porosimetry preferably has two or more peaks, more preferably two or more and four or less peaks, still more preferably two peaks.

The pore distribution curve is obtained by mercury porosimetry under the following measurement conditions.

As a pore distribution measurement apparatus, AutoPore IV model 9250 (micromeritics manufactured by SHIMADZU SCIENCE EAST CORPORATION) is used; 0.1 g of a sample of the porous polyimide membrane is placed into a 5-cc large-sample standard cell, and measured under a condition of the initial pressure of 6.5 kPa. Mercury parameters are set to the default settings of the apparatus: a mercury contact angle of 130.0 degrees and a mercury surface tension of 485.0 dynes/cm.

### Membrane Thickness

The average membrane thickness of the porous polyimide membrane is not particularly limited, and is selected in accordance with the application.

The porous polyimide membrane may have an average membrane thickness of, for example, 10 μm or more and 1000 μm or less, 20 μm or more and 500 μm or less, or 30 μm or more and 400 μm or less.

For example, in the case of using the porous polyimide membrane as an insulating cover membrane that is a cover membrane in an insulated electric wire described later, the porous polyimide membrane has an average membrane thickness of, from the viewpoint of being better in terms of both of the insulating property and membrane flexural strength, preferably 10 μm or more and 200 μm or less, more preferably 15 μm or more and 100 μm or less, still more preferably 20 μm or more and 50 μm or less.

The average membrane thickness of the porous polyimide membrane is determined by using an eddy-current membrane thickness meter CTR-1500E manufactured by SANKO ELECTRONICS CORPORATION to measure membrane thicknesses at five points in the porous polyimide membrane, and calculating the arithmetic mean of the membrane thicknesses.

### Applications of Porous Polyimide Membrane

Examples of the applications of the porous polyimide membrane include insulating cover membranes that are cover membranes in insulated electric wires described later; separators for batteries such as lithium batteries; separators for electrolytic capacitors; electrolytic membranes for fuel cells etc.; battery electrode materials; separation membranes for gas or liquid; low-dielectric-constant materials; and filtration membranes.

### Method for Producing Porous Polyimide Membrane

The method for producing the porous polyimide membrane according to the present exemplary embodiment is not particularly limited as long as the resultant porous polyimide membrane has a volume resistivity and a porosity that satisfy predetermined ranges.

The porous polyimide membrane according to the present exemplary embodiment may be produced by, for example, a method including a first step of applying a polyimide precursor solution onto a base member to form a coating membrane and subsequently drying the coating membrane to form a film; and a second step including performing heating to imidize the polyimide precursor in the film to form a polyimide membrane and a treatment of removing the resin particles in the membrane.

In the method for producing the porous polyimide membrane according to the present exemplary embodiment, spherical resin particles may be used, to thereby provide a porous polyimide membrane including spherical pores.

Hereinafter, an example of the method for producing the porous polyimide membrane according to the present exemplary embodiment will be described with reference to a drawing. FIG. 2 is a schematic view illustrating an example of the form of the porous polyimide membrane formed from the polyimide precursor solution according to the present exemplary embodiment. FIG. 2 illustrates a base member 31, pores 10A, and a porous polyimide membrane 10.

### First Step

In the first step, a polyimide precursor solution is applied onto a base member to form a coating membrane and subsequently the coating membrane is dried to form a film. The polyimide precursor solution, from the viewpoint of providing a porous polyimide membrane that is better in terms of both of the insulating property and membrane flexural strength, may be the polyimide precursor solution according to the present exemplary embodiment.

In the first step, first, the polyimide precursor solution is prepared. Subsequently, the polyimide precursor solution is applied onto a base member to form a coating membrane and subsequently the coating membrane is dried to form a film including the polyimide precursor. The coating membrane is formed by applying the polyimide precursor solution obtained by the above-described method, onto the base member.

The base member (in FIG. 2, the base member 31) onto which the polyimide precursor solution is applied is selected in accordance with the application of the porous polyimide membrane to be obtained. In the case of using the porous polyimide membrane alone, as the base member, a substrate for forming a polyimide membrane may be used. Alternatively, in the case of using, as a cover membrane covering the surface of a member, the porous polyimide membrane, the member itself may be used as the base member.

Examples of the substrate for forming a porous polyimide membrane include substrates formed of a resin such as polystyrene or polyethylene terephthalate; glass substrates; ceramic substrates; substrates formed of a metal such as iron or stainless steel (SUS); and substrates formed of a composite material that is a combination of some of the foregoing materials.

The substrate for forming a porous polyimide membrane may be subjected to, as needed, for example, a release treatment using a release agent such as a silicone release agent or a fluoro-release agent to form a release layer. It is also effective to roughen the surface of the substrate for forming a porous polyimide membrane, so as to have a profile including sizes close to the particle sizes of the resin particles, to facilitate exposure of the resin particles at the contact surface of the substrate.

Note that, in the case of using, as the cover membrane covering the surface of a member, the porous polyimide membrane, specific examples of the member used as the base member include electric wire bodies in insulated electric wires described later; various base members applied to liquid crystal devices; semiconductor base members in which integrated circuits are formed, wiring base members in which wiring is formed, and base members of printed circuit boards in which electronic components and wiring are formed.

The process of applying, onto the base member, the polyimide precursor solution is not particularly limited; examples include various processes such as a spray-coating process, a spin-coating process, a roll-coating process, a bar-coating process, a slit-die-coating process, and an ink jet coating process.

The amount of polyimide precursor solution applied may be set so as to provide the predetermined membrane thickness.

The film is formed by drying the coating membrane formed on the base member.

The process of drying the coating membrane formed on the base member is not particularly limited; examples include various processes such as heat-drying, natural drying, and vacuum drying. More specifically, the coating membrane may be dried such that the content of the solvent remaining in the film relative to the solid content of the film becomes 50 mass % or less (preferably 30 mass % or less), to form a film.

### Second Step

The second step includes performing heating to imidize the polyimide precursor in the film to form a polyimide membrane and a treatment of removing the resin particles in the membrane.

In the second step, specifically, the film obtained in the first step is heated to cause imidization to proceed, to thereby form a polyimide membrane. Note that, as imidization proceeds to increase the degree of imidization, the polyimide membrane becomes less likely to dissolve in the solvent.

Subsequently, in the second step, a treatment of removing the resin particles is performed. The resin particles are removed, so that the regions where the resin particles are present are turned into pores (pores 10A in FIG. 2), to obtain a porous polyimide membrane (porous polyimide membrane 10 in FIG. 2).

The resin particles may be removed during heating of the film for imidization of the polyimide precursor, or may be removed, after imidization, from the polyimide membrane.

The treatment of removing the resin particles may be performed, from the viewpoint of, for example, removability of the resin particles, during imidization of the polyimide precursor, when the polyimide precursor in the polyimide membrane has a degree of imidization of 10% or more. When the degree of imidization is 10% or more, the shape of the membrane tends to be maintained.

### Treatment of Removing Resin Particles

The treatment of removing the resin particles will be specifically described.

Examples of the treatment of removing the resin particles include a process of heating the resin particles to achieve their removal, a process of using an organic solvent for dissolving the resin particles to achieve their removal, and a process of using, for example, a laser to decompose the resin particles to achieve their removal. Of these, preferred are the process of heating the resin particles to achieve their removal and the process of using an organic solvent for dissolving the resin particles to achieve their removal.

As the process of heating the resin particles to achieve their removal, for example, during imidization of the polyimide precursor, heating for causing imidization to proceed may be performed to decompose the resin particles to achieve their removal. In this case, the procedure of using an organic solvent to remove the resin particles is not performed, which results in reduction in the number of steps.

In the case of heating the resin particles to achieve their removal to form a porous structure, the resin particles are not decomposed at the post-application drying temperature, but are thermally decomposed at the imidization temperature for the film of the polyimide precursor. From this viewpoint, the resin particles may have a thermal decomposition onset temperature of 150° C. or more and 320° C. or less, preferably 180° C. or more and 300° C. or less, more preferably 200° C. or more and 280° C. or less.

The process of using an organic solvent dissolving the resin particles to achieve their remove is, for example, a process of bringing the resin particles into contact with the organic solvent dissolving the resin particles (for example, immersing the resin particles in the organic solvent), to dissolve the resin particles to achieve their removal. The process of immersing the resin particles in the organic solvent may provide high dissolution efficiency of the resin particles.

The organic solvent for dissolving the resin particles is not particularly limited as long as the organic solvent does not dissolve the polyimide membrane or the polyimide membrane in which imidization is complete, and dissolves the resin particles. Examples of the organic solvent include ethers such as tetrahydrofuran (THF); aromatics such as toluene; ketones such as acetone; and esters such as ethyl acetate.

In the case of dissolving the resin particles to achieve their removal to form a porous structure, the resin particles that are dissolved in general-purpose solvents such as tetrahydrofuran, acetone, toluene, and ethyl acetate may be used. Note that, depending on the types of the resin particles and polyimide precursor employed, water may be used as the solvent for removing the resin particles.

### Treatment of Removing Inorganic Particles

When the polyimide precursor solution include, as needed, inorganic particles, the inorganic particles can be removed by the following treatment.

The treatment of removing the inorganic particles may be a process of using a liquid that dissolves the inorganic particles but does not dissolve the polyimide precursor or the polyimide (hereafter, may be referred to as “particle removal liquid”). The particle removal liquid is selected in accordance with the type of inorganic particles employed. Examples of the particle removal liquid include aqueous solutions of acids such as hydrofluoric acid, hydrochloric acid, hydrobromic acid, boric acid, perchloric acid, phosphoric acid, sulfuric acid, nitric acid, acetic acid, trifluoroacetic acid, and citric acid; and aqueous solutions of bases such as sodium hydroxide, potassium hydroxide, tetramethylammonium hydroxide, sodium carbonate, potassium carbonate, ammonia, and the above-described organic amines. Alternatively, depending on the types of inorganic particles and polyimide precursor employed, water alone may be used as the liquid for removing the inorganic particles.

### Imidization

In the second step, heating for imidizing the polyimide precursor in the film may be, for example, multistep heating constituted by two or more steps. Specifically, for example, the following heating conditions are employed.

For the heating conditions in the first step, the temperature may be a temperature at which the shapes of the resin particles (in the case of including inorganic particles, also the shapes of the inorganic particles) are maintained. The heating temperature in the first step may be in the range of 50° C. or more and 150° C. or less, is preferably in the range of 60° C. or more and 140° C. or less. The heating time in the first step may be in the range of 10 minutes or more and 60 minutes or less. The higher the heating temperature in the first step, the shorter the heating time in the first step.

The heating conditions of the second step may be, for example, 150° C. or more and 450° C. or less (preferably 200° C. or more and 400° C. or less) and 20 minutes or more and 120 minutes or less. Heating conditions satisfying such ranges cause the imidization reaction to proceed further. During the heating reaction, before the final heating temperature is reached, heating may be performed such that the temperature is increased stepwise or gradually at a constant rate.

Note that the heating conditions are not limited to the above-described two-step heating process; for example, a one-step heating process may be employed. In the case of employing the one-step heating process, for example, the above-described heating conditions in the second step alone may be employed to complete imidization.

Note that, in the case of using the porous polyimide membrane alone, in the second step, the substrate for forming the polyimide membrane used in the first step may be released when the membrane becomes a dry film, may be released when the polyimide precursor in the polyimide membrane becomes less likely to dissolve in the organic solvent, or may be released when the membrane reaches completion of imidization.

### Degree of Imidization

Hereinafter, the degree of imidization of the polyimide precursor will be described.

The polyimide precursor partially imidized is, for example, a precursor having a structure having units represented by the following General formula (I-1), General formula (I-2), and General formula (I-3).

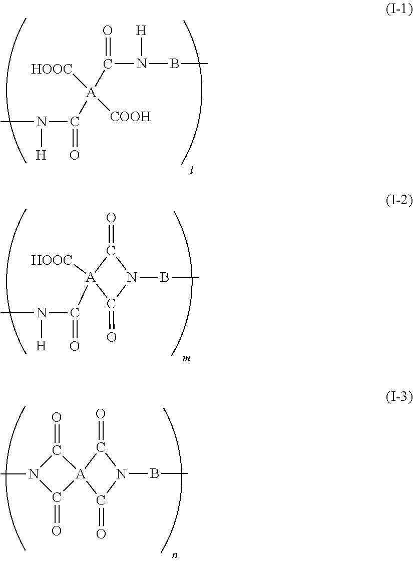

In General formula (I-1), General formula (I-2), and General formula (I-3), A represents a tetravalent organic group and B represents a divalent organic group; 1 represents an integer of 1 or more, and m and n each independently represent an integer of 0 or 1 or more.

Note that, in General formulas (I-1), (I-2), and (I-3), A and B have the same definitions as in A and B in General formula (I) above.

The degree of imidization of the polyimide precursor is, in the bonding moieties in the polyimide precursor (reaction moieties between a tetracarboxylic dianhydride and a diamine compound), the ratio of the number of imide-cyclized bonding moieties (2n+m) to the total number of bonding moieties (2l+2m+2n). Specifically, the degree of imidization of the polyimide precursor is represented by “(2n+m)/(2l+2m+2n)”.

Note that the degree of imidization of the polyimide precursor (value of “(2n+m)/(2l+2m+2n)”) is measured in the following manner.

### Preparation of Sample for Measurement of Degree of Imidization of Polyimide Precursor

(i) The polyimide precursor solution to be measured is applied onto a silicone wafer so as to have a membrane thickness of 1 μm or more and 10 μm or less, to prepare a coating membrane sample.

(ii) The coating membrane sample is immersed in tetrahydrofuran (THF) for 20 minutes to replace the solvent in the coating membrane sample by tetrahydrofuran (THF). The solvent for immersion is not limited to THF and selected from solvents that do not dissolve the polyimide precursor and is miscible with the solvent component included in the polyimide precursor solution. Specific examples include alcohol solvents such as methanol and ethanol and ether compounds such as dioxane.

(iii) The coating membrane sample is taken out from THF; N₂ gas is blown to THF adhering to the surface of the coating membrane sample, to remove THF. The coating membrane sample is treated under a reduced pressure of 10 mmHg or less in the range of 5° C. or more and 25° C. or less for 12 hours or more to dry the coating membrane sample, to prepare a polyimide precursor sample.

### Preparation of 100% Imidized Standard Sample

(iv) As in (i) above, the polyimide precursor solution to be measured is applied onto a silicone wafer, to prepare a coating membrane sample.

(v) The coating membrane sample is heated at 380° C. for 60 minutes to cause an imidization reaction, to prepare a 100% imidized standard sample.

### Measurement and Analysis

(vi) A Fourier transform infrared spectrophotometer (manufactured by HORIBA, Ltd., FT-730) is used to measure the infrared absorption spectra of the 100% imidized standard sample and the polyimide precursor sample. For the 100% imidized standard sample, a ratio I′ (100) of an absorption peak near 1780 cm⁻¹ derived from imide bonds (Ab′ (1780 cm⁻¹)) to an absorption peak near 1500 cm⁻¹ derived from aromatic rings (Ab′ (1500 cm⁻¹)) is determined.

(vii) Similarly, the polyimide precursor sample is measured, and a ratio I(x) of an absorption peak near 1780 cm⁻¹ derived from imide bonds (Ab(1780 cm⁻¹)) to an absorption peak near 1500 cm⁻¹ derived from aromatic rings (Ab(1500 cm⁻¹)) is determined.

Subsequently, the measured absorption peak ratios I′ (100) and I(x) are used to calculate, by the following formula, the degree of imidization of the polyimide precursor.

degree of imidization of polyimide precursor=I(x)/I′ (100) Formula:

I′ (100)=(Ab′ (1780 cm⁻¹))/(Ab′ (1500 cm⁻¹)) Formula:

I(x)=(Ab(1780 cm⁻¹))/(Ab(1500 cm⁻¹)) Formula:

Note that this measurement of the degree of imidization of the polyimide precursor is applied to the measurement of the degree of imidization of an aromatic polyimide precursor. In the case of measuring the degree of imidization of an aliphatic polyimide precursor, instead of the absorption peak derived from aromatic rings, a peak derived from a structure that does not change before and after the imidization reaction is used as the internal standard peak.

The steps having been described so far provide a porous polyimide membrane. The porous polyimide membrane may be subjected to, depending on the usage purpose, post-step processing.

### Defoaming Treatment Step of Polyimide Precursor Solution

The method for producing the porous polyimide membrane according to the present exemplary embodiment may have, as needed, a step of, prior to formation of the coating membrane of the polyimide precursor solution, subjecting the polyimide precursor solution to a defoaming treatment.

In the case of subjecting the polyimide precursor solution to the defoaming treatment, compared with a case of not performing the defoaming treatment, a porous polyimide membrane in which defects are suppressed tends to be obtained.

The process of the defoaming treatment is not particularly limited, and may be defoaming under a reduced pressure (reduced-pressure defoaming) or defoaming under standard pressure. The defoaming treatment under standard pressure may be performed by, for example, a process of applying a centrifugal force by rotation or revolution. Note that, in the case of defoaming under standard pressure or defoaming under a reduced pressure, as needed, the defoaming treatment may be performed under a treatment such as stirring or heating. As the defoaming treatment, the defoaming treatment under a reduced pressure may be simple and provide high defoamability. Conditions of the defoaming treatment may be set in accordance with the amount of residual bubbles.

### Insulated Electric Wire

An insulated electric wire according to the present exemplary embodiment includes an electric wire body, and the above-described porous polyimide membrane disposed on the surface of the electric wire body. In the insulated electric wire according to the present exemplary embodiment, as the insulating cover membrane serving as a cover membrane covering the electric wire body, the above-described porous polyimide membrane is used.

The examples of the electric wire body include wire rods, bars, and plates formed of a metal or an alloy such as annealed copper, hard-drawn-copper, oxygen-free copper, chrome ore, aluminum, aluminum alloy, nickel, silver, soft iron, steel, or stainless steel. The electric wire body may be stranded wires in which plural wire rods are stranded.

The thickness of the electric wire body is not particularly limited, and may be, for example, in the range of 0.1 or more and 5.0 mm or less. Note that the thickness of the electric wire body means the long diameter of a cross section (perpendicular to the longitudinal direction) of the electric wire body.

The porous polyimide membrane is disposed, for example, so as to surround the outer peripheral surface of the electric wire body. The porous polyimide membrane may cover the entirety of the outer peripheral surface of the electric wire body, or may cover a portion of the outer peripheral surface of the electric wire body.

The porous polyimide membrane may be disposed in contact with the surface of the electric wire body or on another layer on the surface of the electric wire body. The other layer that may be disposed between the electric wire body and the porous polyimide membrane may be, for example, an inner semiconducting layer.

On the outer peripheral surface of the porous polyimide layer, another layer may be disposed. The other layer that may be disposed on the outer peripheral surface of the porous polyimide layer may be, for example, an outer semiconducting layer.

The porous polyimide membrane serving as an insulating cover membrane may be formed by applying, to the outer peripheral surface of the electric wire body, the above-described polyimide precursor solution, and performing drying, imidization, and removal of the resin particles. Alternatively, a film obtained by applying the polyimide precursor solution to the surface of a substrate for forming a polyimide membrane and drying the solution, a polyimide membrane obtained by baking the film to cause imidization, or a porous polyimide membrane obtained by baking the film to cause imidization and removal of the resin particles may be released from the substrate for forming a polyimide membrane, placed on the outer peripheral surface of the electric wire body, and subjected to, as needed, for example, heating, to form the insulating cover membrane.

### EXAMPLES

Hereinafter, the present disclosure will be described further in detail with reference to Examples; however, the present disclosure is not limited to the following Examples. In the following Examples, for example, materials, usage amounts, ratios, and the orders of performing treatments can be appropriately changed without departing from the spirit and scope of the present disclosure. Note that “parts” means “parts by mass” unless otherwise specified.

### Preparation of Resin Particle Dispersion Liquid

Styrene (670 parts by mass), 12.1 parts by mass of surfactant Dowfax 2A1 (47% solution, manufactured by The Dow Chemical Company), and 670 parts by mass of ion-exchanged water are mixed together, and stirred and emulsified in Dissolver at 1,500 rpm for 30 minutes, to prepare a monomer emulsion liquid.

Into a reaction vessel, 1.10 parts by mass of Dowfax 2A1 (47% solution, manufactured by The Dow Chemical Company) and 1500 parts by mass of ion-exchanged water are placed. Under a stream of nitrogen, heating to 75° C. is performed; subsequently, 70 parts by mass of the monomer emulsion liquid is added and then a polymerization initiator solution prepared by dissolving 15 parts by mass of ammonium persulfate in 98 parts by mass of ion-exchanged water is added dropwise over 10 minutes. After the dropwise addition, the reaction is caused for 50 minutes; subsequently, the remainder of the monomer emulsion liquid is added dropwise over 220 minutes to cause the reaction for another 50 minutes, and then cooling is performed to obtain a resin particle dispersion liquid. The resin particles are found to have an average particle size of 0.81 μm.

### Example A1

### Preparation of Polyimide Precursor Solution

To 170 parts by mass of the resin particle dispersion liquid, 28 parts by mass (96 molar parts) of 3,3′,4,4′-biphenyltetracarboxylic dianhydride (BPDA), 10 parts by mass (96 molar parts) of p-phenylenediamine (PDA), and 360 parts by mass of ion-exchanged water are added and stirred at 20° C. for 10 minutes.

Subsequently, 22.3 parts by mass (6.5 equivalents) of N-methylmorpholine (tertiary organic amine compound) serving as the ionization agent X and 5.4 parts by mass (1.5 equivalents) of 4-methylimidazole (tertiary organic amine compound) serving as the ionization agent Y are gradually added; while the reaction temperature of 65° C. is maintained, stirring is performed for 20 hours to cause dissolution and reaction, to generate Polyimide precursor (A1) from BPDA and PDA; to this, 200 parts by mass of Polyalkylene oxide-containing liquid (C1) is slowly added, to obtain a polyimide precursor solution of Example A1.

Properties of the obtained polyimide precursor solution will be described in Table 1-1. The polyimide precursor solution of Example A1 is found to have a resin particle content of 60 mass %. Polyimide precursor (A1) contained in the polyimide precursor solution is found to have a weight-average molecular weight of 40000. The resin particles have, in the particle size distribution curve (abscissa axis: 500 nm or more and 2 μm or less), a single maximum alone.

### Preparation of Porous Polyimide Membrane

The polyimide precursor solution obtained in each of Examples is applied onto a glass substrate having a thickness of 1.0 mm, using an applicator, so as to have an area of 10 cm×10 cm, and dried in an oven at 80° C. for 30 minutes to form a film. Note that the gap of the applicator is adjusted such that the dry film has an average film thickness of 30 μm. The glass substrate on which the film is formed is left at rest in an oven at a heating temperature of 400° C. for 2 hours to bake the film; subsequently, the film is immersed in ion-exchanged water to thereby be released from the glass substrate, and dried, to obtain a porous polyimide membrane.

### Examples A2 to A5, B1 to 4, and Comparative Examples 1 to 3

The materials and values are set as described in Table 1-1, to obtain polyimide precursor solutions and porous polyimide membranes of Examples.

For the polyimide precursor solution of each of Examples, the types and boiling points of ionization agents, the boiling point difference between the ionization agent X and the ionization agent Y, the content of the ionization agent X, and the equivalent ratio (X/Y) of the ionization agent X to the ionization agent Y will be described in Table 1-1.

For the porous polyimide membrane of each of Examples, the porosity measured by the above-described method and the number of peaks in the pore distribution curve will be described in Table 1-2.

Note that, in Table 1-1, “-” means not including the ionization agent X or the ionization agent Y.

### Evaluation of Membrane Strength

For the porous polyimide membrane of each of Examples, tensile strength is measured by a tensile test according to ISO 527:2012. Specifically, from the porous polyimide membrane, an ISO multipurpose test specimen is prepared, and the test specimen is set in a universal testing machine (Autograph AG-Xplus, manufactured by SHIMADZU CORPORATION) and subjected to a tensile test to determine tensile strength (MPa).

### Evaluation of Insulating Property

The above-described measurement method is used for the porous polyimide membrane of each of Examples to determine the common logarithm of volume resistivity. The results will be described in Table 1-2.

TABLE 1-1

| | Polyimide precursor solution | | | | | | | |
|---|---|---|---|---|---|---|---|---|
| | Ionization agent X | | | Ionization agent Y | | | Boiling point | |
| | | Boiling | | | Boiling | | difference | Equivalent |
| | | point | Content | | point | Content | (Y − X) | ratio |
| Example | Type | [° C.] | [equivalent] | Type | [° C.] | [equivalent] | [° C.] | (X/Y) |
| Example A1 | 4-Methylmorpholine | 116 | 6.5 | 4-Methylimidazole | 263 | 1.5 | 147 | 4.3 |
| Example A2 | 4-Methylmorpholine | 116 | 18 | 4-Methylimidazole | 263 | 1.5 | 147 | 12.0 |
| Example A3 | 4-Methylmorpholine | 116 | 1.5 | 4-Methylimidazole | 263 | 1.5 | 147 | 1.0 |
| Example A4 | 4-Methylmorpholine | 116 | 22 | 4-Methylimidazole | 263 | 0.9 | 147 | 24.4 |
| Example A5 | 4-Methylmorpholine | 116 | 0.8 | 4-Methylimidazole | 263 | 1.5 | 147 | 0.5 |
| Example B1 | Triethylamine | 89 | 6 | 4-Methylimidazole | 263 | 1.5 | 174 | 4.0 |
| Example B2 | Triethylamine | 89 | 20 | 4-Methylimidazole | 263 | 0.9 | 174 | 22.2 |
| Example B3 | Triethylamine | 89 | 3 | 4-Methylimidazole | 263 | 3.0 | 174 | 1.0 |
| Example B4 | 2-Methylpyridine | 128 | 5 | Propylene carbonate | 242 | 1.4 | 114 | 3.6 |
| Comparative | Triethylamine | 89 | 6.5 | Aminomethylpropanol | 165.5 | 2.0 | 76.5 | 3.3 |
| Example 1 | | | | | | | | |
| Comparative | Triethylamine | 89 | 6.5 | — | — | 0.0 | — | — |
| Example 2 | | | | | | | | |
| Comparative | — | — | 0 | — | — | 0.0 | — | — |
| Example 3 | | | | | | | | |

TABLE 1-2

| | Porous polyimide membrane | | | |
|---|---|---|---|---|
| | | Number of | Tensile | Common logarithm |
| | Porosity | peaks in pore | strength | of volume resistivity |
| Example | [%] | distribution curve | [MPa] | [logΩ · cm] |
| Example A1 | 61 | 2 | 51 | 14.0 |
| Example A2 | 64 | 3 | 51 | 13.7 |
| Example A3 | 59 | 2 | 48 | 14.1 |
| Example A4 | 67 | 3 | 52 | 13.6 |
| Example A5 | 60 | 2 | 47 | 14.3 |
| Example B1 | 60 | 2 | 42 | 13.3 |
| Example B2 | 62 | 3 | 44 | 13.1 |
| Example B3 | 60 | 2 | 37 | 13.6 |
| Example B4 | 61 | 2 | 40 | 13.5 |
| Comparative | 60 | 1 | 40 | 12.8 |
| Example 1 | | | | |
| Comparative | 60 | 1 | 31 | 12.4 |
| Example 2 | | | | |
| Comparative | 60 | 0 | 20 | 12.0 |
| Example 3 | | | | |

As described in Tables, the porous polyimide membranes formed from the polyimide precursor solutions of Examples are, compared with porous polyimide membranes formed from the polyimide precursor solutions of Comparative Examples, good in terms of both of the insulating property and membrane flexural strength.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. A polyimide precursor solution comprising:
an aqueous solvent including water;
a polyimide precursor;
resin particles; and
an ionization agent X having a boiling point of 100° C. or more and 130° C. or less and an ionization agent Y having a boiling point of 250° C. or more and 300° C. or less.

2. A polyimide precursor solution comprising:
an aqueous solvent including water;
a polyimide precursor;
resin particles; and
an ionization agent X having a boiling point of 80° C. or more and an ionization agent Y having a higher boiling point than the ionization agent X,
wherein the ionization agent X and the ionization agent Y have a boiling point difference (Y−X) of 100° C. or more and 200° C. or less.

3. The polyimide precursor solution according to claim 1, wherein a content of the ionization agent X is 1 equivalent or more and 20 equivalents or less of the polyimide precursor.

4. The polyimide precursor solution according to claim 2, wherein a content of the ionization agent X is 1 equivalent or more and 20 equivalents or less of the polyimide precursor.

5. The polyimide precursor solution according to claim 3, wherein the content of the ionization agent X is 2 equivalents or more and 15 equivalents or less of the polyimide precursor.

6. The polyimide precursor solution according to claim 4, wherein the content of the ionization agent X is 2 equivalents or more and 15 equivalents or less of the polyimide precursor.

7. The polyimide precursor solution according to claim 1, wherein an equivalent ratio (X/Y) of the ionization agent X to the ionization agent Y is 1 or more and 30 or less.

8. The polyimide precursor solution according to claim 2, wherein an equivalent ratio (X/Y) of the ionization agent X to the ionization agent Y is 1 or more and 30 or less.

9. The polyimide precursor solution according to claim 3, wherein an equivalent ratio (X/Y) of the ionization agent X to the ionization agent Y is 1 or more and 30 or less.

10. The polyimide precursor solution according to claim 4, wherein an equivalent ratio (X/Y) of the ionization agent X to the ionization agent Y is 1 or more and 30 or less.

11. The polyimide precursor solution according to claim 5, wherein an equivalent ratio (X/Y) of the ionization agent X to the ionization agent Y is 1 or more and 30 or less.

12. The polyimide precursor solution according to claim 6, wherein an equivalent ratio (X/Y) of the ionization agent X to the ionization agent Y is 1 or more and 30 or less.

13. The polyimide precursor solution according to claim 7, wherein the equivalent ratio (X/Y) of the ionization agent X to the ionization agent Y is 2 or more and 20 or less.

14. The polyimide precursor solution according to claim 8, wherein the equivalent ratio (X/Y) of the ionization agent X to the ionization agent Y is 2 or more and 20 or less.

15. The polyimide precursor solution according to claim 1, wherein the ionization agent X and the ionization agent Y include an organic amine compound.

16. The polyimide precursor solution according to claim 15, wherein the ionization agent X is selected, as the organic amine compound, from morpholines represented by General formula (MO) below, and
the ionization agent Y is selected, as the organic amine compound, from imidazoles represented by General formula (IM) below: 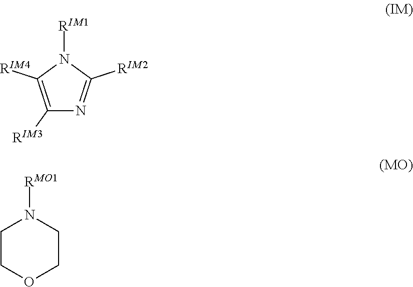
in General formula (IM), R^{IM1}, R^{IM2}, R^{IM3}, and R^{IM4} each independently represent a hydrogen atom or an alkyl group having 1 or more and 8 or less carbon atoms; in General formula (MO), R^{MO1} represents a hydrogen atom or an alkyl group having 1 or more and 8 or less carbon atoms.

17. The polyimide precursor solution according to claim 1, wherein the resin particles have a single maximum alone in a particle size distribution curve.

18. A porous polyimide membrane having a common logarithm of volume resistivity of 13 log Ω·cm or more and a porosity of 50% or more and 70% or less.

19. The porous polyimide membrane according to claim 18, wherein the porous polyimide membrane subjected to mercury porosimetry provides a pore distribution curve having two or more peaks.

20. An insulated electric wire comprising:
an electric wire body; and
the porous polyimide membrane according to claim 18 disposed on a surface of the electric wire body.
